(19) United States
(12) Patent Application Publication
(10) Pub. No.: US 2017/0171773 A1
(43) Pub. Date: Jun. 15, 2017

(54) BACKOFF COMPENSATION OBSS PACKET DETECTION DEVICE AND METHOD

(71) Applicants: Laurent Cariou, Portland, OR (US); Po-Kai Huang, West Lafayette, IN (US); Qinghua Li, San Ramon, CA (US)

(72) Inventors: Laurent Cariou, Portland, OR (US); Po-Kai Huang, West Lafayette, IN (US); Qinghua Li, San Ramon, CA (US)

(21) Appl. No.: 14/968,444

(22) Filed: Dec. 14, 2015

(51) Int. Cl. H04W 28/04; H04W 40/18

(52) U.S. Cl. CPC H04W 28/04; H04W 40/18; H04W 84/12

(57) ABSTRACT

A station (STA), an access point (AP) and method of adjusting for detection of an Overlapping Basic Service Set (OBSS) packet is disclosed. The STA may initiate a counter in response to determining that a BSS packet is to be transmitted. A packet may be detected on the channel and the counter suspended. If the packet is a BSS packet, the counter may be reset and restarted. If the packet is an OBSS packet, the counter may be decremented by a time to detect and determine that the packet is the OBSS packet and subsequently restarted prior to transmitting the BSS packet when the counter reaches 0. The counter may be further decremented by an Inter Frame Space period. If the counter after being decremented is 0, the BSS packet may be transmitted immediately, the counter may not be decremented or may be incremented by a backoff window.

### TECHNICAL FIELD

Embodiments pertain to wireless networks. Some embodiments relate to wireless local area networks (WLANs) and Wi-Fi networks including networks operating in accordance with the IEEE 802.11 family of standards, such as the IEEE 802.11ac standard, the IEEE 802.1 lax study group (SG) (named DensiFi) or IEEE 802.11ay. Some embodiments relate to channel access by a station (STA). Some embodiments relate to STA contention and backoff procedures. Some embodiments relate to compensation for channel use by STA in the presence of Overlapping Basic Service Set (OBSS) transmissions.

### BACKGROUND

The use of personal communication devices has increased astronomically over the last two decades. The penetration of mobile devices (also referred to as stations (STAs)), as well as the rapid increase in Machine Type Communication (MTC) devices for the Internet of Things (IoT), in modern society has continued to drive demand for a wide variety of networked devices in a number of disparate environments. The use of networked STAs using a variety of communication protocols has increased in all areas of home and work life. Unfortunately, the vast explosion of wireless devices has oftentimes resulted in a paucity of spectrum resources. To increase network resources, operators have continued to install an increasing number of access points (APs) for communications between the STAs and the network. An AP together with associated STAs may form a Basic Service Set (BSS), the basic building block of an IEEE 802.11 Wireless Land Area Network (WLAN). Not infrequently, the coverage area of APs overlap, as does the frequency, creating an Overlapping Basic Service Set (OBSS). The presence of an OBSS, and packets originating therefrom, may cause issues in the contention-based access process of STAs in the BSS by delaying channel access for the STAs.

It would be desirable for STAs of the BSS to be able to adjust for packet reception from OBSS during channel contention.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various embodiments discussed in the present document.

FIG. 1 is a functional diagram of a wireless network in accordance with some embodiments.

FIG. 2 illustrates components of a communication device in accordance with some embodiments.

FIG. 3 illustrates a block diagram of a communication device in accordance with some embodiments.

FIG. 4 illustrates another block diagram of a communication device in accordance with some embodiments.

FIG. 5 illustrates a flowchart of data transmission in accordance with some embodiments.

### DETAILED DESCRIPTION OF THE INVENTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

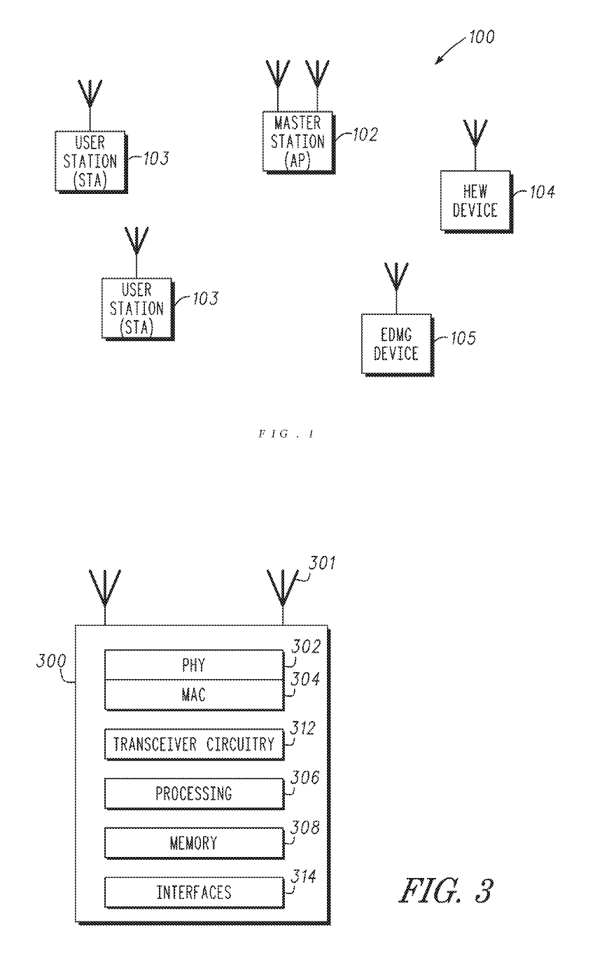

FIG. 1 illustrates a wireless network in accordance with some embodiments. Elements in the network 100 may engage in OBSS compensation, as described herein. In some embodiments, the network 100 may be an Enhanced Directional Multi Gigabit (EDMG) network. In some embodiments, the network 100 may be a High Efficiency Wireless Local Area Network (HEW) network. In some embodiments, the network 100 may be a Wireless Local Area Network (WLAN) or a Wi-Fi network. These embodiments are not limiting, however, as some embodiments of the network 100 may include a combination of such networks. As an example, the network 100 may support EDMG devices in some cases, non EDMG devices in some cases, and a combination of EDMG devices and non EDMG devices in some cases. As another example, the network 100 may support HEW devices in some cases, non HEW devices in some cases, and a combination of HEW devices and non HEW devices in some cases. As another example, some devices supported by the network 100 may be configured to operate according to EDMG operation and/or HEW operation and/or legacy operation. Accordingly, it is understood that although techniques described herein may refer to a non EDMG device, an EDMG device, a non HEW device or an HEW device, such techniques may be applicable to any or all such devices in some cases.

The network 100 may include any number (including zero) of master stations (STA) 102, user stations (STAs) 103 (legacy STAs), HEW stations 104 (HEW devices), and EDMG stations 105 (EDMG devices). It should be noted that in some embodiments, the master station 102 may be a stationary non-mobile device, such as an access point (AP). In some embodiments, the STAs 103 may be legacy stations. These embodiments are not limiting, however, as the STAs 103 may be HEW devices or may support HEW operation in some embodiments. In some embodiments, the STAs 103 may be EDMG devices or may support EDMG operation. It should be noted that embodiments are not limited to the number of master STAs 102, STAs 103, HEW stations 104 or EDMG stations 105 shown in the example network 100 in FIG. 1. Legacy STAs 103 may include, for example, non-HT STA (e.g., IEEE 802.11a/g stations), HT STA (e.g., IEEE 802.11n stations), and VHT STA (e.g., IEEE 802.11ac stations).

The master station 102 may be arranged to communicate with the STAs 103 and/or the HEW stations 104 and/or the EDMG stations 105 in accordance with one or more of the IEEE 802.11 standards. In accordance with some HEW embodiments, an AP may operate as the master station 102 and may be arranged to contend for a wireless medium (e.g., during a contention period) to receive exclusive control of the medium for an HEW control period (i.e., a transmission opportunity (TXOP)). The master station 102 may, for example, transmit a master-sync or control transmission at the beginning of the HEW control period to indicate, among other things, which HEW stations 104 are scheduled for communication during the HEW control period. During the HEW control period, the scheduled HEW stations 104 may communicate with the master station 102 in accordance with a non-contention based multiple access technique. This is unlike conventional Wi-Fi communications in which devices communicate in accordance with a contention-based communication technique, rather than a non-contention based multiple access technique. During the HEW control period, the master station 102 may communicate with HEW stations 104 using one or more HEW frames. During the HEW control period, STAs 103 not operating as HEW devices may refrain from communicating in some cases. In some embodiments, the master-sync transmission may be referred to as a control and schedule transmission.

In some embodiments, a first STA 103 may transmit a grant frame to a second STA 103 to indicate a transmission of a data payload on primary channel resources or on secondary channel resources. The first STA 103 may receive an acknowledgement message for the grant frame from the second STA 103. The first STA 103 may transmit a data payload to the second STA 103 in the channel resources indicated in the grant frame. These embodiments will be described in more detail below.

In some embodiments, the multiple-access technique used during the HEW control period may be a scheduled orthogonal frequency division multiple access (OFDMA) technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique including a multi-user (MU) multiple-input multiple-output (MIMO) (MU-MIMO) technique. These multiple-access techniques used during the HEW control period may be configured for uplink or downlink data communications.

The master station 102 may also communicate with STAs 103 and/or other legacy stations in accordance with legacy IEEE 802.11 communication techniques. In some embodiments, the master station 102 may also be configurable to communicate with the HEW stations 104 outside the HEW control period in accordance with legacy IEEE 802.11 communication techniques, although this is not a requirement.

In some embodiments, the HEW communications during the control period may be configurable to use one of 20 MHz, 40 MHz, or 80 MHz contiguous bandwidths or an 80+80 MHz (160 MHz) non-contiguous bandwidth. In some embodiments, a 320 MHz channel width may be used. In some embodiments, subchannel bandwidths less than 20 MHz may also be used. In these embodiments, each channel or subchannel of an HEW communication may be configured for transmitting a number of spatial streams.

In some embodiments, EDMG communication may be configurable to use channel resources that may include one or more frequency bands of 2.16 GHz, 4.32 GHz or other bandwidth. Such channel resources may or may not be contiguous in frequency. As a non-limiting example, EDMG communication may be performed in channel resources at or near a carrier frequency of 60 GHz.

In some embodiments, primary channel resources may include one or more such bandwidths, which may or may not be contiguous in frequency. As a non-limiting example, channel resources spanning a 2.16 GHz or 4.32 GHz bandwidth may be designated as the primary channel resources. As another non-limiting example, channel resources spanning a 20 MHz bandwidth may be designated as the primary channel resources. In some embodiments, secondary channel resources may also be used, which may or may not be contiguous in frequency. As a non-limiting example, the secondary channel resources may include one or more frequency bands of 2.16 GHz bandwidth, 4.32 GHz bandwidth or other bandwidth. As another non-limiting example, the secondary channel resources may include one or more frequency bands of 20 MHz bandwidth or other bandwidth.

In some embodiments, the primary channel resources may be used for transmission of control messages, beacon frames or other frames or signals by the AP 102. As such, the primary channel resources may be at least partly reserved for such transmissions. In some cases, the primary channel resources may also be used for transmission of data payloads and/or other signals. In some embodiments, the transmission of the beacon frames may be restricted such that the AP 102 does not transmit beacons on the secondary channel resources. Accordingly, beacon transmission may be reserved for the primary channel resources and may be restricted and/or prohibited in the secondary channel resources, in some cases.

In accordance with embodiments, a master station 102 and/or HEW stations 104 may generate an HEW packet in accordance with a short preamble format or a long preamble format. The HEW packet may comprise a legacy signal field (L-SIG) followed by one or more high-efficiency (HE) signal fields (HE-SIG) and an HE long-training field (HE-LTF). For the short preamble format, the fields may be configured for shorter-delay spread channels. For the long preamble format, the fields may be configured for longer-delay spread channels. These embodiments are described in more detail below. It should be noted that the terms “HEW” and “HE” may be used interchangeably and both terms may refer to high-efficiency Wireless Local Area Network operation and/or high-efficiency Wi-Fi operation.

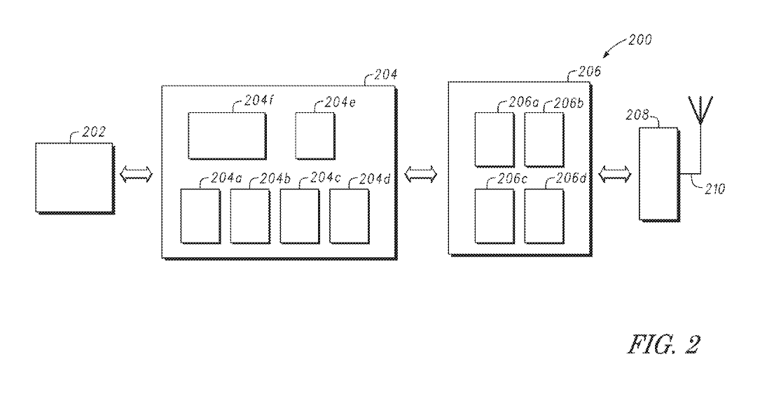

Embodiments described herein may be implemented into a system using any suitably configured hardware and/or software. FIG. 2 illustrates components of a communication device in accordance with some embodiments. The communication device 200 may be one of the UEs 102a or STAs 103 shown in FIG. 1 and may be a stationary, non-mobile device or may be a mobile device. In some embodiments, the communication device 200 may include application circuitry 202, baseband circuitry 204, Radio Frequency (RF) circuitry 206, front-end module (FEM) circuitry 208 and one or more antennas 210, coupled together at least as shown. At least some of the baseband circuitry 204, RF circuitry 206, and FEM circuitry 208 may form a transceiver. In some embodiments, other network elements, such as the eNB or AP may contain some or all of the components shown in FIG. 2.

The application or processing circuitry 202 may include one or more application processors. For example, the application circuitry 202 may include circuitry such as, but not limited to, one or more single-core or multi-core processors. The processor(s) may include any combination of general-purpose processors and dedicated processors (e.g., graphics processors, application processors, etc.). The processors may be coupled with and/or may include memory/storage and may be configured to execute instructions stored in the memory/storage to enable various applications and/or operating systems to run on the system.

The baseband circuitry 204 may include circuitry such as, but not limited to, one or more single-core or multi-core processors. The baseband circuitry 204 may include one or more baseband processors and/or control logic to process baseband signals received from a receive signal path of the RF circuitry 206 and to generate baseband signals for a transmit signal path of the RF circuitry 206. Baseband processing circuitry 204 may interface with the application circuitry 202 for generation and processing of the baseband signals and for controlling operations of the RF circuitry 206. For example, in some embodiments, the baseband circuitry 204 may include a second generation (2G) baseband processor 204a, third generation (3G) baseband processor 204b, fourth generation (4G) baseband processor 204c, and/or other baseband processor(s) 204d for other existing generations, generations in development or to be developed in the future (e.g., fifth generation (5G), 6G, etc.). The baseband circuitry 204 (e.g., one or more of baseband processors 204a-d) may handle various radio control functions that enable communication with one or more radio networks via the RF circuitry 206. The radio control functions may include, but are not limited to, signal modulation/demodulation, encoding/decoding, radio frequency shifting, etc. In some embodiments, modulation/demodulation circuitry of the baseband circuitry 204 may include Fast-Fourier Transform (FFT), precoding, and/or constellation mapping/demapping functionality. In some embodiments, encoding/decoding circuitry of the baseband circuitry 204 may include convolution, tail-biting convolution, turbo, Viterbi, and/or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 204 may include elements of a protocol stack such as, for example, elements of an evolved universal terrestrial radio access network (EUTRAN) and/or IEEE 802.11 protocol including, for example, physical (PHY), media access control (MAC), radio link control (RLC), packet data convergence protocol (PDCP), and/or radio resource control (RRC) elements. A central processing unit (CPU) 204e of the baseband circuitry 204 may be configured to run elements of the protocol stack for signaling of the PHY, MAC, RLC, PDCP and/or RRC layers. In some embodiments, the baseband circuitry may include one or more audio digital signal processor(s) (DSP) 204f. The audio DSP(s) 204f may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 204 and the application circuitry 202 may be implemented together such as, for example, on a system on a chip (SOC).

In some embodiments, the baseband circuitry 204 may provide for communication compatible with one or more radio technologies. For example, in some embodiments, the baseband circuitry 204 may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry 204 is configured to support radio communications of more than one wireless protocol may be referred to as multi-mode baseband circuitry. In some embodiments, the device can be configured to operate in accordance with communication standards or other protocols or standards, including Institute of Electrical and Electronic Engineers (IEEE) 802.16 wireless technology (WiMax), IEEE 802.11 wireless technology (WiFi) including IEEE 802 ad, which operates in the 60 GHz millimeter wave spectrum, and 802.11 lax, various other wireless technologies such as global system for mobile communications (GSM), enhanced data rates for GSM evolution (EDGE), GSM EDGE radio access network (GERAN), universal mobile telecommunications system (UMTS), UMTS terrestrial radio access network (UTRAN), or other 2G, 3G, 4G, 5G, etc. technologies either already developed or to be developed.

RF circuitry 206 may enable communication with wireless networks using modulated electromagnetic radiation through a non-solid medium. In various embodiments, the RF circuitry 206 may include switches, filters, amplifiers, etc. to facilitate the communication with the wireless network. RF circuitry 206 may include a receive signal path which may include circuitry to down-convert RF signals received from the FEM circuitry 208 and provide baseband signals to the baseband circuitry 204. RF circuitry 206 may also include a transmit signal path which may include circuitry to up-convert baseband signals provided by the baseband circuitry 204 and provide RF output signals to the FEM circuitry 208 for transmission.

In some embodiments, the RF circuitry 206 may include a receive signal path and a transmit signal path. The receive signal path of the RF circuitry 206 may include mixer circuitry 206a, amplifier circuitry 206b and filter circuitry 206c. The transmit signal path of the RF circuitry 206 may include filter circuitry 206c and mixer circuitry 206a. RF circuitry 206 may also include synthesizer circuitry 206d for synthesizing a frequency for use by the mixer circuitry 206a of the receive signal path and the transmit signal path. In some embodiments, the mixer circuitry 206a of the receive signal path may be configured to down-convert RF signals received from the FEM circuitry 208 based on the synthesized frequency provided by synthesizer circuitry 206d. The amplifier circuitry 206b may be configured to amplify the down-converted signals and the filter circuitry 206c may be a low-pass filter (LPF) or band-pass filter (BPF) configured to remove unwanted signals from the down-converted signals to generate output baseband signals. Output baseband signals may be provided to the baseband circuitry 204 for further processing. In some embodiments, the output baseband signals may be zero-frequency baseband signals, although this is not a requirement. In some embodiments, mixer circuitry 206a of the receive signal path may comprise passive mixers, although the scope of the embodiments is not limited in this respect.

In some embodiments, the mixer circuitry 206a of the transmit signal path may be configured to up-convert input baseband signals based on the synthesized frequency provided by the synthesizer circuitry 206d to generate RF output signals for the FEM circuitry 208. The baseband signals may be provided by the baseband circuitry 204 and may be filtered by filter circuitry 206c. The filter circuitry 206c may include a low-pass filter (LPF), although the scope of the embodiments is not limited in this respect.

In some embodiments, the mixer circuitry 206a of the receive signal path and the mixer circuitry 206a of the transmit signal path may include two or more mixers and may be arranged for quadrature downconversion and/or upconversion respectively. In some embodiments, the mixer circuitry 206a of the receive signal path and the mixer circuitry 206a of the transmit signal path may include two or more mixers and may be arranged for image rejection (e.g., Hartley image rejection). In some embodiments, the mixer circuitry 206a of the receive signal path and the mixer circuitry 206a may be arranged for direct downconversion and/or direct upconversion, respectively. In some embodiments, the mixer circuitry 206a of the receive signal path and the mixer circuitry 206a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 206 may include analog-to-digital converter (ADC) and digital-to-analog converter (DAC) circuitry and the baseband circuitry 204 may include a digital baseband interface to communicate with the RF circuitry 206.

In some dual-mode embodiments, a separate radio IC circuitry may be provided for processing signals for each spectrum, although the scope of the embodiments is not limited in this respect.

In some embodiments, the synthesizer circuitry 206d may be a fractional-N synthesizer or a fractional N/N+1 synthesizer, although the scope of the embodiments is not limited in this respect as other types of frequency synthesizers may be suitable. For example, synthesizer circuitry 206d may be a delta-sigma synthesizer, a frequency multiplier, or a synthesizer comprising a phase-locked loop with a frequency divider.

The synthesizer circuitry 206d may be configured to synthesize an output frequency for use by the mixer circuitry 206a of the RF circuitry 206 based on a frequency input and a divider control input. In some embodiments, the synthesizer circuitry 206d may be a fractional N/N+1 synthesizer.

In some embodiments, frequency input may be provided by a voltage controlled oscillator (VCO), although that is not a requirement. Divider control input may be provided by either the baseband circuitry 204 or the applications processor 202 depending on the desired output frequency. In some embodiments, a divider control input (e.g., N) may be determined from a look-up table based on a channel indicated by the applications processor 202.

Synthesizer circuitry 206d of the RF circuitry 206 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 206d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (f_{LO}). In some embodiments, the RF circuitry 206 may include an IQ/polar converter.

FEM circuitry 208 may include a receive signal path which may include circuitry configured to operate on RF signals received from one or more antennas 210, amplify the received signals and provide the amplified versions of the received signals to the RF circuitry 206 for further processing. FEM circuitry 208 may also include a transmit signal path which may include circuitry configured to amplify signals for transmission provided by the RF circuitry 206 for transmission by one or more of the one or more antennas 210.

In some embodiments, the FEM circuitry 208 may include a TX/RX switch to switch between transmit mode and receive mode operation. The FEM circuitry may include a receive signal path and a transmit signal path. The receive signal path of the FEM circuitry may include a low-noise amplifier (LNA) to amplify received RF signals and provide the amplified received RF signals as an output (e.g., to the RF circuitry 206). The transmit signal path of the FEM circuitry 208 may include a power amplifier (PA) to amplify input RF signals (e.g., provided by RF circuitry 206), and one or more filters to generate RF signals for subsequent transmission (e.g., by one or more of the one or more antennas 210.

In some embodiments, the communication device 200 may include additional elements such as, for example, memory/storage, display, camera, sensor, and/or input/output (I/O) interface as described in more detail below. In some embodiments, the communication device 200 described herein may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), or other device that may receive and/or transmit information wirelessly. In some embodiments, the UE 200 may include one or more user interfaces designed to enable user interaction with the system and/or peripheral component interfaces designed to enable peripheral component interaction with the system. For example, the UE 200 may include one or more of a keyboard, a keypad, a touchpad, a display, a sensor, a non-volatile memory port, a universal serial bus (USB) port, an audio jack, a power supply interface, one or more antennas, a graphics processor, an application processor, a speaker, a microphone, and other I/O components. The display may be an LCD or LED screen including a touch screen. The sensor may include a gyro sensor, an accelerometer, a proximity sensor, an ambient light sensor, and a positioning unit. The positioning unit may communicate with components of a positioning network, e.g., a global positioning system (GPS) satellite.

The antennas 210 may comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas 210 may be effectively separated to take advantage of spatial diversity and the different channel characteristics that may result.

Although the communication device 200 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. Some embodiments may include one or more processors and may be configured with instructions stored on a computer-readable storage device.

FIG. 3 is a block diagram of a communication device in accordance with some embodiments. The communication device 300 may be a STA 103 or AP 102 shown in FIG. 1. In addition, the communication device 300 may also be suitable for use as an HEW device 104 as shown in FIG. 1, such as an HEW station. In some embodiments, the communication device 300 may be suitable for use as an EDMG device 105 as shown in FIG. 1, such as an EDMG station. Some of the components shown in FIG. 3 may not be present in all of the devices in FIG. 1.

The communication device 300 may include physical layer circuitry 302 for enabling transmission and reception of signals to and from the master station 102, HEW devices 104, EDMG devices 105, other STAs 103, APs and/or other devices using one or more antennas 201. The physical layer circuitry 302 may perform various encoding and decoding functions that may include formation of baseband signals for transmission and decoding of received signals. The communication device 300 may also include medium access control layer (MAC) circuitry 304 for controlling access to the wireless medium. The communication device 300 may also include processing circuitry 306, such as one or more single-core or multi-core processors, and memory 308 arranged to perform the operations described herein. The physical layer circuitry 302, MAC circuitry 304 and processing circuitry 306 may handle various radio control functions that enable communication with one or more radio networks compatible with one or more radio technologies. The radio control functions may include signal modulation, encoding, decoding, radio frequency shifting, etc. For example, similar to the device shown in FIG. 2, in some embodiments, communication may be enabled with one or more of a WMAN, a WLAN, and a WPAN. In some embodiments, the communication device 300 can be configured to operate in accordance with 3GPP standards or other protocols or standards, including WiMax, WiFi, GSM, EDGE, GERAN, UMTS, UTRAN, or other 3G, 3G, 4G, 5G, etc. technologies either already developed or to be developed. The communication device 300 may include transceiver circuitry 312 to enable communication with other external devices wirelessly and interfaces 314 to enable wired communication with other external devices. As another example, the transceiver circuitry 312 may perform various transmission and reception functions such as conversion of signals between a baseband range and a Radio Frequency (RF) range.

The antennas 301 may comprise one or more directional or omnidirectional antennas, including, for example, dipole antennas, monopole antennas, patch antennas, loop antennas, microstrip antennas or other types of antennas suitable for transmission of RF signals. In some MIMO embodiments, the antennas 301 may be effectively separated to take advantage of spatial diversity and the different channel characteristics that may result.

Although the communication device 300 is illustrated as having several separate functional elements, one or more of the functional elements may be combined and may be implemented by combinations of software-configured elements, such as processing elements including DSPs, and/or other hardware elements. For example, some elements may comprise one or more microprocessors. DSPs, FPGAs, ASICs, RFICs and combinations of various hardware and logic circuitry for performing at least the functions described herein. In some embodiments, the functional elements may refer to one or more processes operating on one or more processing elements. Embodiments may be implemented in one or a combination of hardware, firmware and software. Embodiments may also be implemented as instructions stored on a computer-readable storage device, which may be read and executed by at least one processor to perform the operations described herein.

In some embodiments, the communication device 300 may be configured as an HEW device 104 (FIG. 1) and/or an EDMG device 105 (FIG. 1), and may communicate using OFDM communication signals over a multicarrier communication channel. Accordingly, in some cases the communication device 300 may be configured to receive signals in accordance with specific communication standards, such as the Institute of Electrical and Electronics Engineers (IEEE) standards including IEEE 802.11-2012, 802.11n-2009 and/or 802.11ac-2013 standards and/or proposed specifications for WLANs including proposed HEW standards and/or proposed EDMG standards, although the scope of the invention is not limited in this respect as they may also be suitable to transmit and/or receive communications in accordance with other techniques and standards. In some other embodiments, the communication device 300 configured as an HEW device 104 may be configured to receive signals that were transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In accordance with embodiments, the STA 103 may transmit a grant frame to indicate a transmission of a data payload by the STA 103 during a grant period. The grant frame may indicate whether the data payload is to be transmitted on primary channel resources or on secondary channel resources. The STA 103 may transmit the data payload to a destination STA 103 on the secondary channel resources when the grant frame indicates that the data payload is to be transmitted on the secondary channel resources. The grant frame may be transmitted on the primary channel resources and on the secondary channel resources when the grant frame indicates that the data payload is to be transmitted on the secondary channel resources. When the grant frame indicates that the data payload is to be transmitted on the primary channel resources, the grant frame may be transmitted on the primary channel resources and the STA 103 may refrain from transmission of the grant frame on the secondary channel resources. These embodiments will be described in more detail below.

In some embodiments, the channel resources may be used for downlink transmission by the AP 102 and for uplink transmissions by the STAs 103. That is, a time-division duplex (TDD) format may be used. In some embodiments, the channel resources may be used for direct communication between one or more STAs 103. For instance, the STAs 103 may be configured to communicate in a peer-to-peer (P2P) mode. As another example, the STAs 103 may be configured to communicate in a non Port Control Protocol/AP (non-PCP/AP) mode.

In some cases, the channel resources may include multiple channels, such as the 20 MHz channels or 2.16 GHz channels previously described. The channels may include multiple sub-channels or may be divided into multiple sub-channels for the uplink transmissions to accommodate multiple access for multiple STAs 103. The downlink transmissions and/or the direct transmissions between STAs 103 may or may not utilize the same format.

In some embodiments, the sub-channels may comprise a predetermined bandwidth. As a non-limiting example, the sub-channels may each span 2.03125 MHz, the channel may span 20 MHz, and the channel may include eight or nine sub-channels. Although reference may be made to a sub-channel of 2.03125 MHz for illustrative purposes, embodiments are not limited to this example value, and any suitable frequency span for the sub-channels may be used. In some embodiments, the frequency span for the sub-channel may be based on a value included in an 802.11 standard (such as 802.11ax and/or 802.11ay), a 3GPP standard or other standard.

In some embodiments, the sub-channels may comprise multiple sub-carriers. Although not limited as such, the sub-carriers may be used for transmission and/or reception of OFDM or OFDMA signals. As an example, each sub-channel may include a group of contiguous sub-carriers spaced apart by a pre-determined sub-carrier spacing. As another example, each sub-channel may include a group of non-contiguous sub-carriers. That is, the channel may be divided into a set of contiguous sub-carriers spaced apart by the pre-determined sub-carrier spacing, and each sub-channel may include a distributed or interleaved subset of those sub-carriers. The sub-carrier spacing may take a value such as 78.125 kHz, 312.5 kHz or 15 kHz, although these example values are not limiting. Other suitable values that may or may not be part of an 802.11 or 3GPP standard or other standard may also be used in some cases. As an example, for a 78.125 kHz sub-carrier spacing, a sub-channel may comprise 26 contiguous sub-carriers or a bandwidth of 2.03125 MHz.

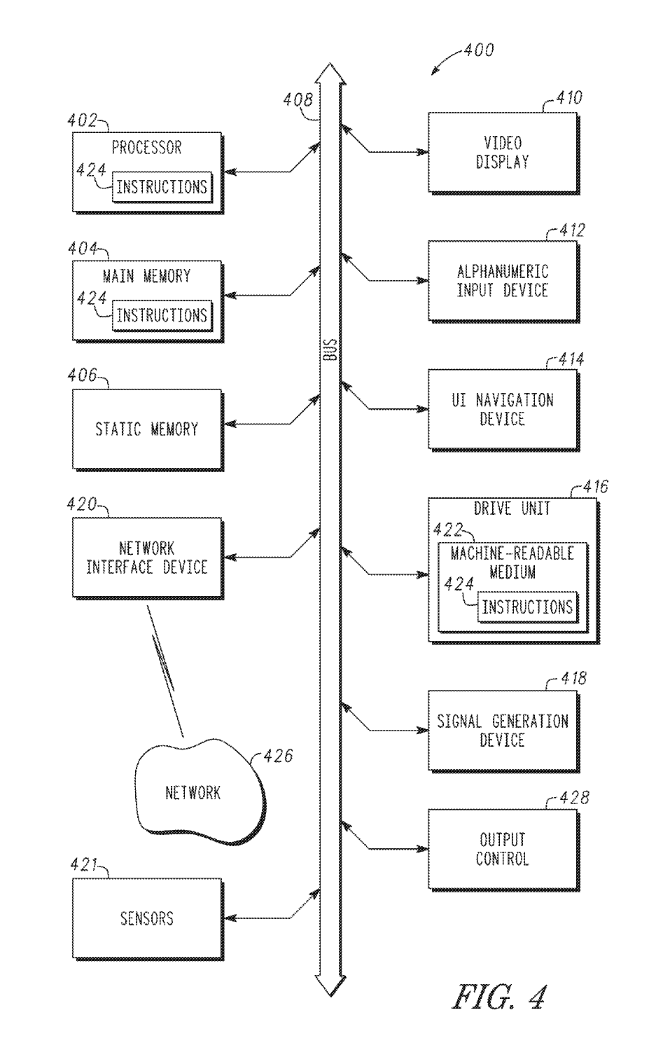

FIG. 4 illustrates another block diagram of a communication device in accordance with some embodiments. In alternative embodiments, the communication device 400 may operate as a standalone device or may be connected (e.g., networked) to other communication devices. In a networked deployment, the communication device 400 may operate in the capacity of a server communication device, a client communication device, or both in server-client network environments. In an example, the communication device 400 may act as a peer communication device in peer-to-peer (P2P) (or other distributed) network environment. The communication device 400 may be a UE, eNB, AP, STA, PC, a tablet PC, a STB, a PDA, a mobile telephone, a smart phone, a web appliance, a network router, switch or bridge, or any communication device capable of executing instructions (sequential or otherwise) that specify actions to be taken by that communication device. Further, while only a single communication device is illustrated, the term “communication device” shall also be taken to include any collection of communication devices that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a communication device readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Communication device (e.g., computer system) 400 may include a hardware processor 402 (e.g., a central processing unit (CPU), a graphics processing unit (GPU), a hardware processor core, or any combination thereof), a main memory 404 and a static memory 406, some or all of which may communicate with each other via an interlink (e.g., bus) 408. The communication device 400 may further include a display unit 410, an alphanumeric input device 412 (e.g., a keyboard), and a user interface (UI) navigation device 414 (e.g., a mouse). In an example, the display unit 410, input device 412 and UI navigation device 414 may be a touch screen display. The communication device 400 may additionally include a storage device (e.g., drive unit) 416, a signal generation device 418 (e.g., a speaker), a network interface device 420, and one or more sensors 421, such as a global positioning system (GPS) sensor, compass, accelerometer, or other sensor. The communication device 400 may include an output controller 428, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 416 may include a communication device readable medium 422 on which is stored one or more sets of data structures or instructions 424 (e.g., software) embodying or utilized by any one or more of the techniques or functions described herein. The instructions 424 may also reside, completely or at least partially, within the main memory 404, within static memory 406, or within the hardware processor 402 during execution thereof by the communication device 400. In an example, one or any combination of the hardware processor 402, the main memory 404, the static memory 406, or the storage device 416 may constitute communication device readable media.

While the communication device readable medium 422 is illustrated as a single medium, the term “communication device readable medium” may include a single medium or multiple media (e.g., a centralized or distributed database, and/or associated caches and servers) configured to store the one or more instructions 424.

The term “communication device readable medium” may include any medium that is capable of storing, encoding, or carrying instructions for execution by the communication device 400 and that cause the communication device 400 to perform any one or more of the techniques of the present disclosure, or that is capable of storing, encoding or carrying data structures used by or associated with such instructions. Non-limiting communication device readable medium examples may include solid-state memories, and optical and magnetic media. Specific examples of communication device readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, communication device readable media may include non-transitory communication device readable media. In some examples, communication device readable media may include communication device readable media that is not a transitory propagating signal.

The instructions 424 may further be transmitted or received over a communications network 426 using a transmission medium via the network interface device 420 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., IEEE 802.11 family of standards, IEEE 802.16 family of standards), IEEE 802.15.4 family of standards, a LTE family of standards, a Universal Mobile Telecommunications System (UMTS) family of standards, peer-to-peer (P2P) networks, among others. In an example, the network interface device 420 may include one or more physical jacks (e.g., Ethernet, coaxial, or phone jacks) or one or more antennas to connect to the communications network 426. In an example, the network interface device 420 may include a plurality of antennas to wirelessly communicate using at least one of single-input multiple-output (SIMO), MIMO, or multiple-input single-output (MISO) techniques. In some examples, the network interface device 420 may wirelessly communicate using Multiple User MIMO techniques. The term “transmission medium” shall be taken to include any intangible medium that is capable of storing, encoding or carrying instructions for execution by the communication device 400, and includes digital or analog communications signals or other intangible medium to facilitate communication of such software.

The upcoming protocol 802.11ax may provide up to four multiple-input-multiple-output (MIMO) spatial streams, with each stream multiplexed using orthogonal frequency division access (OFDA). A Carrier Sense/Clear Channel Assessment (CS/CCA) technique may be used to determine the state of the medium in a distributed environment. The CS/CCA procedure may be executed while the STA 103 is not currently receiving or transmitting a packet. The CS/CCA procedure may be used to detect the start of a network signal that can be received (CS) and to determine whether the channel is clear prior to transmitting a packet (CCA). A broadcast packet may be transmitted from the AP 102 on a channel based on a distributed coordination function (DCF) mechanism.

During the CS/CCA procedure, each STA 103 may maintain a backoff counter having random backoff time. The use of a random backoff time may help to reduce the collision probability between multiple STAs accessing a medium when collisions are most likely to occur, which may be immediately after the medium becomes free as multiple STAs may have been waiting for the medium to become available. A STA 103 wishing to transmit a buffered data packet may first sense the channel to determine the channel status. If the channel is idle for a period of time greater than the DCF Inter Frame Space (DIFS) period and the backoff counter of the STA 103 reaches zero, the STA 103 may transmit the data packet during a transmission opportunity (TXOP).

Specifically, the STA 103 may transmit a request to send (RTS) to the AP 102. After a Short Inter Frame Space (SIFS) period, if the medium is available, the AP 102 may respond to the RTS by broadcasting a clear to send (CTS). After the CTS is received by the STA 103, the STA 103 may wait until the backoff counter of the STA 103 reaches zero. The STA 103 may then transmit the data packet to the AP 102 during the TXOP. If the medium becomes busy before the backoff counter of the STA 103 reaches zero, the STA 103 may sense when the medium again becomes available and transmit another RTS to the AP 102.

After each transmission, the STA 103 may pick a new backoff time. Assuming the STA 103 received an acknowledgment (ACK) from the AP 102 indicating reception of the packet by the AP 102, if the backoff counter expires before the next packet arrives for transmission, the STA 103 can transmit after sensing the channel to be idle for the DIFS period. If the last transmission was unsuccessful, as evidenced by the lack of reception of the ACK by the STA 103, the STA 103 may wait for an Extended Inter Frame Space (EIFS) period, which is longer than the DIFS period. If the STA 103 has a data packet waiting for transmission and the backoff counter expires, but the carrier sensing detects that the carrier is occupied, the STA 103 may select a second backoff time for the backoff counter and transmit the packet when the second backoff time has expired.

In some embodiments, STAs may use a Short Inter Frame Space (SIFS) used for RTS/CTS and for a positive ACK-based high priority transmission. Once the SIFS duration elapses, the transmission can immediately start. Depending on the physical layer configuration, the SIFS duration may be 6, 10 or 28 μs. A PCF Inter Frame Space (PIFS) may be used by the PCF during contention free operations. After the PIFS period elapses, STAs having data to be transmitted in contention free period can be initiated, preempting contention based traffic. The DIFS period is the minimum idle time for contention based services. STAs may access the channel immediately if it is free after the DIFS period. The EIFS period may be used, as above, when there is erroneous frame transmission. The Arbitration Inter Frame Space period (AIFS) may be used by QoS STAs to transmit all frames (data and control).

In particular, the CCA process may be performed by the physical layer. The physical layer can be divided into two sublayers. The sublayers may include the physical medium dependent (PMD, lower sublayer) and the physical layer convergence procedure (PLCP, upper sublayer). The physical layer may determine whether the channel is clear and communicate this to the MAC layer. The PMD may indicate to the PLCP sublayer whether the medium is in use. The PLCP sublayer may communicate with the MAC layer to indicate a busy or idle medium, which may prevent the MAC layer from attempting to forward a frame for transmission. CCA, may include both energy detection (ED) and CS. For the CS CCA process, the STA 103 may detect and decode a WiFi preamble from the PLCP header field. For the ED CCA process, the STA 103 may detect non-WiFi energy in the operating channel and backoff data transmission. The ED threshold may be dependent in some embodiments on the channel width. If the non-WiFi energy exceeds the ED threshold for a predetermined amount of time, the STA 103 may determine that the medium is busy until the energy is below the threshold.

The basic service set (BSS) includes a single AP 102 together with all associated STAs controlled by the AP 102. Each BSS is uniquely identified by a basic service set identification (BSSID). The coverage area of the AP 102, the BSA, may cover up to 7-10 meters.

The 802.11 standard defines an Overlapping Basic Service Set (OBSS) as a BSS operating on the same channel as a BSS of a STA 103 and either partly or wholly within the BSA of the STA 103. OBSS environments result from over-crowded deployments of WLAN systems. A centrally-coordinated set of service sets, including a BSS and OBSS, may be assigned non-overlapping frequency channels and therefore may not result in data throughput issues. In many environments, however, the BSS and OBSS in a BSA are not coordinated and may use one or more of the same 20 MHz primary and secondary channels. This may cause interference between APs 102 and STAs 103 during the competition for channel access, causing increased channel contention and decreased performance.

To increase the BSA throughput, a BSSID indicator may be transmitted in the high-efficiency signal field A (HE-SIGA) of the PLCP header field of each BSS transmission. When a STA 103 receives a packet, the STA 103 may be able to detect from which service set, the BSS or an OBSS, the packet originates. If the packet originates from an OBSS, different CCA rules may be used by the STA 103 to enable to simultaneous transmission. Specifically, if a STA 103 detects an incoming packet from an OBSS, the STA 103 may stop its backoff countdown process.

When the STA 103 detects that the packet is from an OBSS, the STA 103 may apply a different ED CCA process than when the STA 103 detects that the packet is from the BSS. In some embodiments, the STA 103 may set the ED threshold substantially higher, such that the OBSS transmission may degrade the signal quality of a BSS transmission by the STA 103 to below a predetermined amount. Thus, the OBSS ED threshold may be higher than the BSS ED threshold, which may be −72 dBm for example. After determining that the OBSS signal power is below the OBSS ED threshold, the STA 103 may resume the countdown process to try to gain channel access.

However, during the process of determining that the transmission is an OBSS transmission and the OBSS transmission is below the OBSS ED threshold, the STA 103 may suspend decrementing of the backoff counter. As the transmission does not originate in the BSS of the STA 103, this suspension may undesirably delay packet transmission by the STA 103. Medium access may also be undesirably weighted towards STAs in the BSS that are capable of ignoring the OBSS packet as compared to the STA 103.

To combat this, the STA 103 may compensate for reception of an OBSS transmission when attempting to transmit a data packet. In some embodiments, the STA 103 may, upon determination that the channel is busy, stop the backoff counter. The STA 103 may determine that the channel is busy by detecting the presence of a packet using SD CCA. However, the STA 103 may not know that the packet is from an OBSS. The STA 103 may detects that the received packet belongs to an OBSS based on the BSS identifier in the PHY PLCP preamble or in the MAC header of the packet. After determining that the packet is an OBSS packet, the STA 103 may resume its countdown process. Based on the OBSS CCA rules, the STA 103 may consider the channel idle over the entirety of the detection and determination period. The STA 103 may decrement the backoff counter by the number of slots of the detection and determination period prior to resuming the countdown process. In one example, if countdown of the STA 103 is stopped with a backoff of 10, and the STA 103 detects that the packet is from an OBSS after 28 μs (the length of 3 slots, which are 9 μs), which corresponds to the length of a high-efficiency signal field A (HE-SIGA), through extraction of the OBSS ID in the high-efficiency signal field A (HE-SIGA) of the PLCP header of the OBSS packet, the STA 103 may resume its backoff countdown starting at 10−3=7.

In some embodiments, the backoff counter of all STAs in the BSS may be synchronized. This may be the case even though the STAs in the BSS may be able to detect that the packet is from OBSS at different times because of implementation constraints. In this embodiment, the STAs may wait for a xIFS period after determination that the received packet is an OBSS packet before restarting the countdown set by the backoff counter. The xIFS period may be any IFS period, such as a DIFS period, a SIFS period, a PIFS period, an EIFS period or an AIFS period. The countdown may restart on the timeslots used before reception of the OBSS packet. In one example, if countdown of the STA 103 is suspended with a backoff of 10, and the STA 103 detects that the packet is from an OBSS, the STA 103 may resume its backoff countdown starting at 10 after the xIFS period.

In some embodiment, rather than restarting the backoff counter at the suspension value, prior to resuming the countdown process after the xIFS period the STA 103 may decrement the backoff counter by the number of slots used during the detection and determination period. In one example, if countdown of the STA 103 is suspended with a backoff of 10, and the STA 103 detects that the packet is from an OBSS after 3 slots, the STA 103 may resume its backoff countdown starting at 10−3=7 after the xIFS period.

In some embodiments, the STA 103 may take into account the xIFS period when restarting the backoff counter. In such embodiments, prior to resuming the countdown process after the xIFS period, the STA 103 may decrement the backoff counter by the number of slots used during the detection and determination period and during the xIFS period. In one example, if countdown of the STA 103 is suspended with a backoff of 10, and the STA 103 detects that the packet is from an OBSS after 3 slots and the xIFS period is 3 slots, the STA 103 may resume its backoff countdown starting at 10−3−3=4 after the xIFS period.

In some embodiments, the STA 103 may take into account the xIFS period when restarting the backoff counter. In such embodiments, prior to resuming the countdown process after the xIFS period, the STA 103 may decrement the backoff counter by the number of slots used during the detection and determination period and during the xIFS period. In one example, if countdown of the STA 103 is suspended with a backoff of 10, and the STA 103 detects that the packet is from an OBSS after 3 slots and the xIFS period is 3 slots, the STA 103 may resume its backoff countdown starting at 10−3−3=4 after the xIFS period.

In certain circumstances, decrementation using one or more of the above techniques may lead to a countdown of 0. For example, a backoff counter that is smaller than the detection and determination period may, in either embodiment above, lead to a countdown of 0 when the backoff counter is decremented. When the xIFS period is included, a backoff counter that is smaller than the detection and determination period plus the xIFS period may lead to a countdown of 0 when the backoff counter is decremented. Unfortunately, STAs that have a backoff time of 0 after being decremented may be able to transmit immediately after the detection and determination period, potentially leading to collisions.

In some embodiments, no adjustment may be performed, i.e., some or all of the STAs may be able to transmit either right away or after the xIFS period depending on the embodiment. In some embodiments, decrementing the backoff counter may be disabled for some or all of the STAs. In some embodiments, the backoff counter may be reset using a new random time or a random time may be added to some or all of the STAs before decrementing the backoff counter. In some embodiments, the backoff counter may be decremented dependent on time of the detection and determination period (and perhaps the xIFS period if the xIFS period is included in the decrementing), e.g., proportional to the time rounded either up or down to a whole slot value. For example, if the backoff counter is decremented by 50% of the detection and determination period plus the xIFS period and the detection and determination period is 3 slots and the xIFS period is 2 slots, the backoff counter may be decremented by 2 slots (rounded down) or 3 slots (rounded to the nearest slot). In some embodiments, the backoff counter may be decremented dependent on the remaining time in the backoff counter. For example, with 10 slots remaining in the backoff counter, the backoff counter may be decremented by the entire amount of the detection and determination period (perhaps plus the xIFS period), with 6-9 slots remaining, the backoff counter may be decremented by 50% of the detection and determination period (/xIFS period), with 4-5 slots remaining, the backoff counter may be decremented by 25% of the detection and determination period (/xIFS period) and with 3 or fewer slots, the backoff counter may not be decremented. In some embodiments, the backoff counter may be decremented by the entire amount of the detection and determination period plus the xIFS period, with 6-9 slots remaining, the backoff counter may be decremented by the detection and determination period without the xIFS period, with 4-5 slots remaining, the backoff counter may be decremented by 50% of the detection and determination period and with 3 or fewer slots, the backoff counter may not be decremented.

Which of these embodiments are used may depend on characteristics of the BSS, the remaining time in the backoff counter or external events. For example, if the backoff time is less than a predetermined amount, the STAs may not perform an adjustment. In other examples, the AP 102 or eNB 104a may provide instructions to the STAs 103 based on the number of STAs 103 present in the BSS, the historical uplink transmissions in the BSS (perhaps specific to the period of the day) and/or a social or geo-political event occurring, such as a geographically local sporting event ending. In one example, if only a few STAs are present in the BSS, or the STAs have historically infrequent uplink transmissions, the STAs may not perform an adjustment.

Although various embodiments have described the backoff counter as decrementing to a specific value (e.g., from a predetermined value to 0), in some embodiments, the backoff counter may increment to reach a different value (e.g., from 0 to a predetermined value).

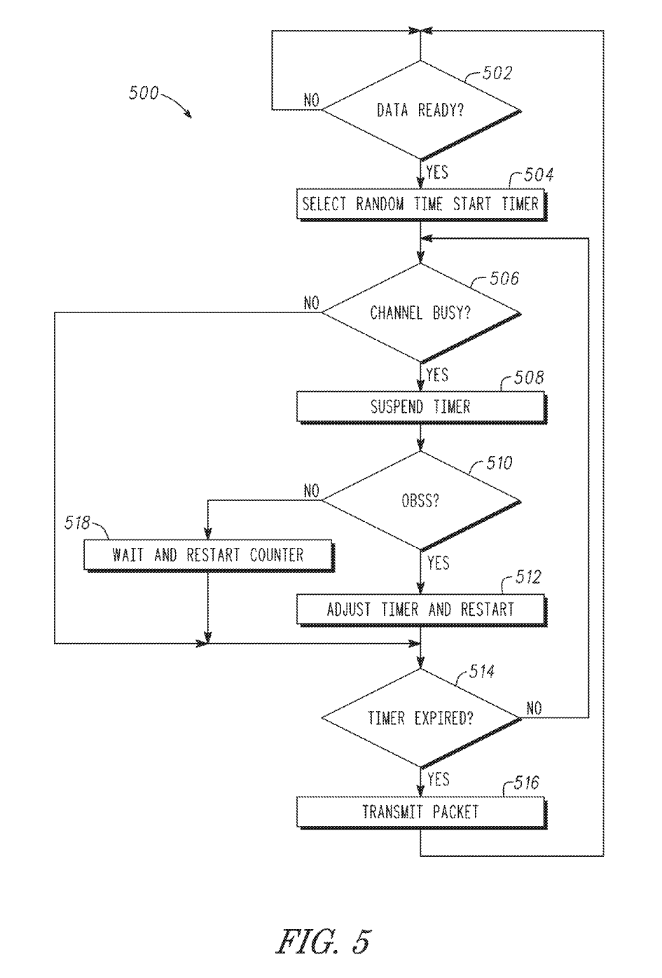

FIG. 5 illustrates a flowchart of data transmission in accordance with some embodiments. The method described by the flowchart may be performed by the STA shown in any of FIGS. 1-4. At operation 502, the STA determines that it has data to transmit to the AP of the BSS of which the STA is a member. The data may be voice, video, text or application-related. The data may be transmitted from the STA to another STA or to a server in the network, for example, via the AP. In some embodiments, such as ad-hoc networks for example, another STA may act as the AP and forward the packet to the network. Similar principals may be applied to device-to-device (D2D) communication when a contention-based access system and randomized backoff counter is used.

Once the STA determines that a data packet is ready to be transmitted, the STA may detect that the channel used to transmit the data packet is idle for a DIFS period. The STA may transmit the data after the DIFS period or may transmit a RTS to the AP, receive a CTS from the AP after a SIFS period, and then transmit data after another SIFS period. In either case, the AP may transmit an ACK a SIFS period after receiving the data. A Net Allocation Vector (NAV) timer may be set for each of the time between the RTS transmission and ACK reception and the CTS and ACK reception to restrain the response of the STA. After another DIFS period after receiving the ACK, the STA may enter a contention period or backoff window. In operation 504, the STA may select a random time for the backoff counter that defines the backoff window to avoid collisions and start the backoff counter.

At operation 506, while the backoff counter is decrementing to 0, the STA may sense whether the channel has become busy. The STA may use an ED process to determine whether energy exceeding the ED threshold is present in the operating channel for a predetermined amount of time. This is to say that the STA may detect the presence of a packet on the channel.

If the STA determines at operation 506 that the channel is busy, the STA may at operation 508 suspend the backoff counter. The backoff counter may be suspended at any point in the backoff counter so long as time remains in the backoff counter. In some embodiments, the STA may run a secondary counter upon suspension of the backoff counter. The secondary counter may increment from 0.

Once the backoff counter is suspended at operation 508, the STA may determine at operation 510 whether the packet is a BSS or an OBSS packet. To determine whether the packet is a BSS or an OBSS packet, the STA may detect and decode the WiFi preamble from the PLCP header field to extract the BSSID of the packet.

If the BSSID matches that of the BSSID used by the BSS with which the STA is associated, the STA may determine that another STA in the BSS is occupying the channel and may wait at operation 518 for the transmission to end. After the end of the transmission, as determined by the ED CCA, the STA may delay for the DIFS period. After the DIFS period, the STA may restart the backoff counter and proceed to operation 514.

If the BSSID does not match that of the BSSID used by the BSS, the STA may determine that the packet is an OBSS packet and may, at operation 512, adjust the timer of the backoff counter and restart the backoff counter. Specifically, the STA may consider the channel idle over the entirety of the detection and determination period as indicated by the secondary counter. In some embodiments the STA may decrement the counter by the secondary counter value and reset the secondary counter. In some embodiments, the STA may continue calculating slot boundaries while the backoff counter is suspended, so that when the STA determines that the packet is an OBSS packet the STA (along with all of the other STAs in the BSS) is able to determine and restart the backoff counter at the next slot boundary. This permits the STAs in the BSS to synchronize to the slot boundaries.

The STA may also wait for a xIFS period after determination that the received packet is an OBSS packet before restarting the countdown set by the backoff counter. The xIFS period may as above be a DIFS period, a SIFS period, a PIFS period, an EIFS period or an AIFS period, among others, depending on the protocol used. In some embodiments, the STA may decrement the backoff counter by the secondary counter value after the xIFS period. In some embodiments, the STA may decrement the backoff counter by the secondary counter value and by the xIFS period after the xIFS period, thereby also taking into account the xIFS period.

The STA may determine in some embodiments that the backoff counter would be decremented to 0 or below. In response, in some embodiments, the STA may continue with the adjustment and permit the STA to transmit either right away or after the xIFS period. In some embodiments, the STA may not decrement or may partially decrement the backoff counter. In some embodiments, the backoff window may be added before decrementing the backoff counter.

After the backoff counter has been restarted, at operation 514 the STA may determine whether the time in the backoff counter has expired. As above, in some embodiments, prior to making this determination, an addition xIFS period may be added to the backoff timer, thereby delaying packet transmission.

Once the time in the backoff counter has expired and the channel is idle, the STA may transmit the packet. As above, the STA may transmit either right away or after the xIFS period if the backoff counter was adjusted to 0. After transmission, the STA may return to operation 502 and enter the contention period where it may contend with other STAs in the BSS to transmit the next packet.

Example 1 is an apparatus of a station (STA) comprising: a transceiver arranged to communicate over a channel with an access point (AP) of a Basic Service Set (BSS) that includes the STA; and processing circuitry arranged to: suspend a backoff counter in response to detection of a packet on the channel; determine that the packet is an Overlapping Basic Service Set (OBSS) packet that has originated from a STA in an OBSS; determine whether to adjust the backoff counter in response to a determination that the packet is the OBSS packet; in response to a determination to adjust the backoff counter, adjust the backoff counter dependent on a time to detect and determine that the packet is the OBSS packet to form an adjusted backoff counter; start the adjusted backoff counter; and configure the transceiver to transmit a BSS packet when the adjusted backoff counter reaches a predetermined value.

In Example 2, the subject matter of Example 1 optionally includes that the processing circuitry is further arranged to: restart the adjusted backoff counter an Inter Frame Space (IFS) period after the time to detect and determine that the packet is the OBSS packet.

In Example 3, the subject matter of Example 2 optionally includes that the processing circuitry is further arranged to: adjust the backoff counter by the time to detect and determine that the OBSS packet is the OBSS packet and the IFS period.

In Example 4, the subject matter of Example 3 optionally includes that the processing circuitry is further arranged to: continue to calculate slot boundaries while the backoff counter is suspended, and in response to a determination that the packet is the OBSS packet, determine an immediately succeeding slot boundary and start the adjusted backoff counter at the immediately succeeding slot boundary.

In Example 5, the subject matter of any one or more of Examples 1-4 optionally include that the processing circuitry is further arranged to: determine that the packet is the OBSS packet by extracting a BSS identification (BSSID) in a high-efficiency signal field A (HE-SIG-A) of a physical layer convergence procedure (PLCP) header of the packet.

In Example 6, the subject matter of any one or more of Examples 1-5 optionally include that the processing circuitry is further arranged to: detect the packet by detecting energy in the channel that exceeds an energy detection (ED) threshold for a predetermined amount of time, and restart the adjusted backoff counter in response to a determination that the energy in the channel is less than an OBSS ED threshold, the OBSS ED threshold greater than the ED threshold.

In Example 7, the subject matter of any one or more of Examples 1-6 optionally include that the processing circuitry is further arranged to: reset the backoff counter to a random value in response to a determination that the packet is a BSS packet.

In Example 8, the subject matter of any one or more of Examples 1-7 optionally include that: the backoff counter is decremented to adjust the backoff counter, during adjustment of the backoff counter, the processing circuitry is arranged to: determine whether a first decrement of the backoff counter would result in the backoff counter falling below the predetermined value, determine whether to change the first decrement based on whether the first decrement would result in the backoff counter falling below the predetermined value, and decrement the backoff counter by a second decrement in response to a determination to change the first decrement, a value of the second decrement being less than a value of the first decrement.

In Example 9, the subject matter of Example 8 optionally includes that the processing circuitry is further arranged to: in response to a determination to change the first decrement, increment the backoff counter prior to a decrement of the backoff counter by the second decrement.

In Example 10, the subject matter of any one or more of Examples 1-9 optionally include that: the backoff counter is decremented to adjust the backoff counter, the processing circuitry is further arranged to decrement the backoff counter by a same amount independent of whether a decrement of the backoff counter would result in the backoff counter falling below the predetermined value.

In Example 11, the subject matter of any one or more of Examples 1-10 optionally include, further comprising an antenna configured to transmit and receive communications between the transceiver and the AP.

Example 12 is an apparatus of an access point (AP) comprising: transceiver circuitry arranged to communicate over a channel with a Basic Service Set (BSS) including a plurality of stations (STAs); and processing circuitry arranged to: detect a packet on the channel; determine that the packet is an Overlapping Basic Service Set (OBSS) packet originating from a STA in an OBSS; and configure the transceiver to receive a BSS packet from one of the plurality of STAs, the BSS packet being received dependent on a backoff counter time adjusted based at least in part on a time to detect and determine that the packet is the OBSS packet.

In Example 13, the subject matter of Example 12 optionally includes that: the backoff counter time includes an Inter Frame Space (IFS) period after the time to detect and determine that the packet is the OBSS packet.

In Example 14, the subject matter of any one or more of Examples 12-13 optionally include that: the OBSS packet comprises a BSS identification (BSSID) in a high-efficiency signal field A (HE-SIGA) of a physical layer convergence procedure (PLCP) header of the packet.

In Example 15, the subject matter of any one or more of Examples 12-14 optionally include that: the packet is detected by detection of energy in the channel that exceeds an energy detection (ED) threshold for a predetermined amount of time, and the BSS packet is received when the energy in the channel is less than an OBSS ED threshold, the OBSS ED threshold greater than the ED threshold.

In Example 16, the subject matter of any one or more of Examples 12-15 optionally include that one of: the BSS packet is received immediately after the time to detect and determine that the packet is the OBSS packet, the BSS packet is received an Inter Frame Space (IFS) period after the time to detect and determine that the packet is the OBSS packet, and the BSS packet is received a backoff window period after the time to detect and determine that the packet is the OBSS packet.

Example 17 is a non-transitory computer-readable storage medium that stores instructions for execution by one or more processors to configure station (STA), the one or more processors to configure the STA to: select a random number to use in a backoff counter for access to a channel for communication with an access point (AP) of a Basic Service Set (BSS); suspend operation of the backoff counter in response to detecting a packet on the channel; in response to determining that the packet originates from the BSS, restart the suspended backoff counter after transmission of the packet; and in response to determining that the packet originates from an Overlapping Basic Service Set (OBSS), determine whether to adjust the suspended backoff counter using an adjustment prior to starting the suspended backoff counter, restart the suspended backoff counter after implementing the adjustment in response to determining to adjust the suspended backoff counter, and transmit the BSS packet when the backoff counter reaches a predetermined value.

In Example 18, the subject matter of Example 17 optionally includes that: the adjustment comprises decrementing the backoff counter by a time to detect and determine that the packet is the OBSS packet.

In Example 19, the subject matter of Example 18 optionally includes that: the adjustment further comprises decrementing the backoff counter by an Inter Frame Space (IFS) period.

In Example 20, the subject matter of any one or more of Examples 17-19 optionally include that: the adjustment comprises a decrement of the backoff counter, and the instructions further configure the STA to: determine whether a first decrement of the backoff counter would result in the backoff counter falling below the predetermined value, determine whether to change the first decrement based on whether the first decrement would result in the backoff counter falling below the predetermined value, and decrement the backoff counter by a second decrement in response to a determination to change the first decrement, a value of the second decrement being less than a value of the first decrement.

In Example 21, the subject matter of Example 20 optionally includes that: in response to a determination to change the first decrement, increment the backoff counter prior to a decrement in the backoff counter by the second decrement.

Example 22 is a method of a station (STA) communicating with an access point (AP), the method comprising: suspending operation of a backoff counter, configured to determine when to transmit to with the AP a Basic Service Set (BSS) packet on a channel, in response to detecting a packet on the channel; determining that the packet originates from an Overlapping Basic Service Set (OBSS) rather than the BSS from a BSS identification (BSSID) in a high-efficiency signal field (HE-SIG) of a physical layer convergence procedure (PLCP) header of the packet; adjusting the suspended backoff counter; starting the suspended backoff counter after adjusting the suspended backoff counter; and transmitting the BSS packet when the backoff counter reaches a predetermined value.

In Example 23, the subject matter of Example 22 optionally includes that: adjusting the backoff counter comprises decrementing the backoff counter by a time to detect and determine that the packet is the OBSS packet.

In Example 24, the subject matter of Example 23 optionally includes that: adjusting the backoff counter further comprises decrementing the backoff counter by an Inter Frame Space (IFS) period.

In Example 25, the subject matter of any one or more of Examples 22-24 optionally include that: adjusting the backoff counter comprises decrementing the backoff counter, and the method further comprises: determining whether a first decrement of the backoff counter would result in the backoff counter falling below the predetermined value, determining whether to change the first decrement based on whether the first decrement would result in the backoff counter falling below the predetermined value, and decrementing the backoff counter by a second decrement in response to determining to change the first decrement, a value of the second decrement being less than a value of the first decrement.

The term “machine readable medium” may include a single medium or multiple media (e.g., a centralized or distributed database, and/or associated caches and servers) configured to store one or more instructions. The term “machine readable medium” may include any medium that is capable of storing, encoding, or carrying instructions for execution by the communication device and that cause it to perform any one or more of the techniques of the present disclosure, or that is capable of storing, encoding or carrying data structures used by or associated with such instructions. The term “transmission medium” shall be taken to include any intangible medium that is capable of storing, encoding or carrying instructions for execution, and includes digital or analog communications signals or other intangible medium to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. An apparatus of a station (STA) comprising:
a transceiver arranged to communicate over a channel with an access point (AP) of a Basic Service Set (BSS) that includes the STA; and
processing circuitry arranged to:
suspend a backoff counter in response to detection of a packet on the channel;
determine that the packet is an Overlapping Basic Service Set (OBSS) packet that has originated from a STA in an OBSS;
determine whether to adjust the backoff counter in response to a determination that the packet is the OBSS packet;
in response to a determination to adjust the backoff counter, adjust the backoff counter dependent on a time to detect and determine that the packet is the OBSS packet to form an adjusted backoff counter;
start the adjusted backoff counter; and
configure the transceiver to transmit a BSS packet when the adjusted backoff counter reaches a predetermined value.

2. The apparatus of claim 1, wherein the processing circuitry is further arranged to:
restart the adjusted backoff counter an Inter Frame Space (IFS) period after the time to detect and determine that the packet is the OBSS packet.

3. The apparatus of claim 2, wherein the processing circuitry is further arranged to:
adjust the backoff counter by the time to detect and determine that the OBSS packet is the OBSS packet and the IFS period.

4. The apparatus of claim 3, wherein the processing circuitry is further arranged to:
continue to calculate slot boundaries while the backoff counter is suspended, and
in response to a determination that the packet is the OBSS packet, determine an immediately succeeding slot boundary and start the adjusted backoff counter at the immediately succeeding slot boundary.

5. The apparatus of claim 1, wherein the processing circuitry is further arranged to:
determine that the packet is the OBSS packet by extracting a BSS identification (BSSID) in a high-efficiency signal field A (HE-SIG-A) of a physical layer convergence procedure (PLCP) header of the packet.

6. The apparatus of claim 1, wherein the processing circuitry is further arranged to:
detect the packet by detecting energy in the channel that exceeds an energy detection (ED) threshold for a predetermined amount of time, and
restart the adjusted backoff counter in response to a determination that the energy in the channel is less than an OBSS ED threshold, the OBSS ED threshold greater than the ED threshold.

7. The apparatus of claim 1, wherein the processing circuitry is further arranged to:
reset the backoff counter to a random value in response to a determination that the packet is a BSS packet.

8. The apparatus of claim 1, wherein:
the backoff counter is decremented to adjust the backoff counter,
during adjustment of the backoff counter, the processing circuitry is arranged to:
determine whether a first decrement of the backoff counter would result in the backoff counter falling below the predetermined value,
determine whether to change the first decrement based on whether the first decrement would result in the backoff counter falling below the predetermined value, and
decrement the backoff counter by a second decrement in response to a determination to change the first decrement, a value of the second decrement being less than a value of the first decrement.

9. The apparatus of claim 8, wherein the processing circuitry is further arranged to:
in response to a determination to change the first decrement, increment the backoff counter prior to a decrement of the backoff counter by the second decrement.

10. The apparatus of claim 1, wherein:
the backoff counter is decremented to adjust the backoff counter,
the processing circuitry is further arranged to decrement the backoff counter by a same amount independent of whether a decrement of the backoff counter would result in the backoff counter falling below the predetermined value.

11. The apparatus of claim 1, further comprising an antenna configured to transmit and receive communications between the transceiver and the AP.

12. An apparatus of an access point (AP) comprising:
transceiver circuitry arranged to communicate over a channel with a Basic Service Set (BSS) including a plurality of stations (STAs); and
processing circuitry arranged to:
detect a packet on the channel;
determine that the packet is an Overlapping Basic Service Set (OBSS) packet originating from a STA in an OBSS; and
configure the transceiver to receive a BSS packet from one of the plurality of STAs, the BSS packet being received dependent on a backoff counter time adjusted based at least in part on a time to detect and determine that the packet is the OBSS packet.

13. The apparatus of claim 12, wherein:
the backoff counter time includes an Inter Frame Space (IFS) period after the time to detect and determine that the packet is the OBSS packet.

14. The apparatus of claim 12, wherein:
the OBSS packet comprises a BSS identification (BSSID) in a high-efficiency signal field A (HE-SIGA) of a physical layer convergence procedure (PLCP) header of the packet.

15. The apparatus of claim 12, wherein:
the packet is detected by detection of energy in the channel that exceeds an energy detection (ED) threshold for a predetermined amount of time, and
the BSS packet is received when the energy in the channel is less than an OBSS ED threshold, the OBSS ED threshold greater than the ED threshold.

16. The apparatus of claim 12, wherein one of:
the BSS packet is received immediately after the time to detect and determine that the packet is the OBSS packet,
the BSS packet is received an Inter Frame Space (IFS) period after the time to detect and determine that the packet is the OBSS packet, and
the BSS packet is received a backoff window period after the time to detect and determine that the packet is the OBSS packet.

17. A non-transitory computer-readable storage medium that stores instructions for execution by one or more processors to configure station (STA), the one or more processors to configure the STA to:
select a random number to use in a backoff counter for access to a channel for communication with an access point (AP) of a Basic Service Set (BSS);
suspend operation of the backoff counter in response to detecting a packet on the channel;
in response to determining that the packet originates from the BSS, restart the suspended backoff counter after transmission of the packet; and
in response to determining that the packet originates from an Overlapping Basic Service Set (OBSS), determine whether to adjust the suspended backoff counter using an adjustment prior to starting the suspended backoff counter, restart the suspended backoff counter after implementing the adjustment in response to determining to adjust the suspended backoff counter, and transmit the BSS packet when the backoff counter reaches a predetermined value.

18. The medium of claim 17, wherein:
the adjustment comprises decrementing the backoff counter by a time to detect and determine that the packet is the OBSS packet.

19. The medium of claim 18, wherein:
the adjustment further comprises decrementing the backoff counter by an Inter Frame Space (IFS) period.

20. The medium of claim 17, wherein:
the adjustment comprises a decrement of the backoff counter, and
the instructions further configure the STA to:
determine whether a first decrement of the backoff counter would result in the backoff counter falling below the predetermined value,
determine whether to change the first decrement based on whether the first decrement would result in the backoff counter falling below the predetermined value, and
decrement the backoff counter by a second decrement in response to a determination to change the first decrement, a value of the second decrement being less than a value of the first decrement.

21. The medium of claim 20, wherein:
in response to a determination to change the first decrement, increment the backoff counter prior to a decrement in the backoff counter by the second decrement.

22. A method of a station (STA) communicating with an access point (AP), the method comprising:
suspending operation of a backoff counter, configured to determine when to transmit to with the AP a Basic Service Set (BSS) packet on a channel, in response to detecting a packet on the channel;
determining that the packet originates from an Overlapping Basic Service Set (OBSS) rather than the BSS from a BSS identification (BSSID) in a high-efficiency signal field (HE-SIG) of a physical layer convergence procedure (PLCP) header of the packet;
adjusting the suspended backoff counter;
starting the suspended backoff counter after adjusting the suspended backoff counter; and
transmitting the BSS packet when the backoff counter reaches a predetermined value.

23. The method of claim 22, wherein:
adjusting the backoff counter comprises decrementing the backoff counter by a time to detect and determine that the packet is the OBSS packet.

24. The method of claim 23, wherein:
adjusting the backoff counter further comprises decrementing the backoff counter by an Inter Frame Space (IFS) period.

25. The method of claim 22, wherein:
adjusting the backoff counter comprises decrementing the backoff counter, and
the method further comprises:
determining whether a first decrement of the backoff counter would result in the backoff counter falling below the predetermined value,
determining whether to change the first decrement based on whether the first decrement would result in the backoff counter falling below the predetermined value, and
decrementing the backoff counter by a second decrement in response to determining to change the first decrement, a value of the second decrement being less than a value of the first decrement.
